(19) United States
(12) Patent Application Publication
(10) Pub. No.: US 2017/0254717 A1
(43) Pub. Date: Sep. 7, 2017

(54) AUTOMATIC VALVE TESTING ASSEMBLY

(71) Applicant: Haskel International, LLC, Burbank, CA (US)

(72) Inventors: John McNEIL, Tujunga, CA (US); Derrick SETO, Monrovia, CA (US); Jeffrey BLUEN, Sherman Oaks, CA (US)

(21) Appl. No.: 15/059,139

(22) Filed: Mar. 2, 2016

(51) Int. Cl. G01M 3/08; G01F 1/42; G01L 3/06

(52) U.S. Cl. CPC G01M 3/086; G01L 3/06; G01F 1/42

(57) ABSTRACT

A test assembly for a valve is provided that comprises a test frame with a bubble catch plate that directs bubbles generated during a valve test towards a gas capture tube where gas flow is directly measured.

### BACKGROUND OF THE INVENTION

Technical Field

The present invention relates to equipment that automatically tests valve bodies for leaks. In particular, the invention relates to equipment used to automatically detect leaks from a valve body or valve actuator during long-term cycle testing in a high pressure marine environment.

Background

Fluid flow valves are known in the art, and typically comprise a valve body with an inlet, an outlet, and a closure member between the inlet and outlet. The closure member can be actuated between an “on” position that allows fluid to flow through the valve, and an “off” position that stops fluid from flowing through the valve, using an actuator that manipulates the position of the closure member from the exterior of the valve body. The closure member can be fully “on” allowing for maximum available throughput, fully “off” completely stopping fluid flow, or partially “on” allowing a fluid flow rate less than maximum possible through the valve body.

Fluid flow valves have particularly important applications in subsea oil and gas exploration and production. Valves located in subsea environments can be subjected to thousands of pounds of pressure, and need to function reliably under such conditions even after thousands of on/off cycles.

### SUMMARY OF THE INVENTION

In one embodiment, a valve test assembly comprises: a test frame; a torque motor secured to the test frame; an actuator shaft coupled to the torque motor; a torque sensor that measures the amount of torque applied to the actuator shaft; a valve attachment area on the test frame; a bubble catch plate secured to the test frame between the valve attachment area and the torque motor; wherein the bubble catch plate comprises a funnel surface facing the valve attachment area, further wherein the bubble catch plate comprises a gas tube orifice connected to a gas capture tube on a side of the bubble catch plate opposite the valve attachment area.

In another embodiment, the funnel surface comprises an angled surface. In another embodiment, the funnel surface comprises at least one groove.

In another embodiment, the valve test assembly further comprises a gas flow meter coupled to the gas capture tube. In another embodiment, the valve test assembly further comprises a valve attached to the valve attachment area of the test frame.

### BRIEF DESCRIPTION OF THE DRAWINGS

The invention may be understood by reference to the following description taken in conjunction with the accompanying drawings, in which, like reference numerals identify like elements, and in which:

FIG. 1 is a cutaway view of one embodiment of a valve test assembly of the present invention; and

FIG. 2 is a cross-sectional view of one embodiment of the valve test assembly of the present invention partially immersed in a fluid bath during a valve test.

### DETAILED DESCRIPTION

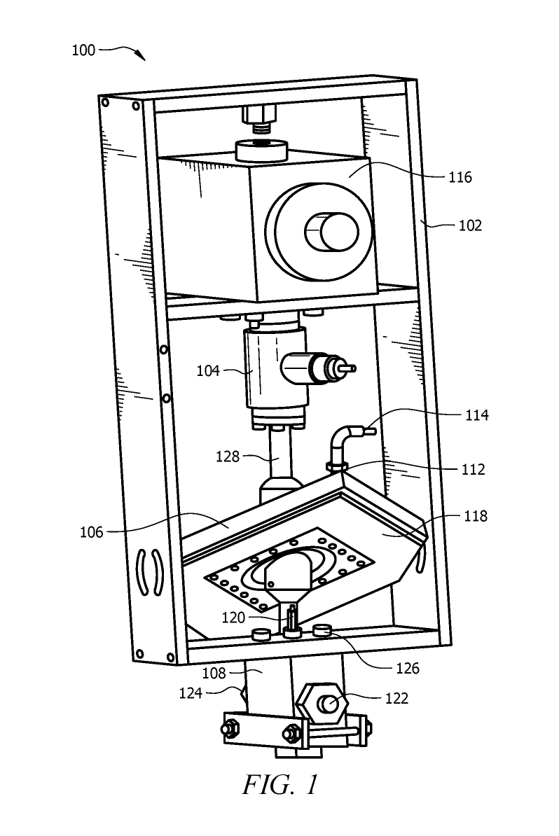

The present invention is an apparatus, method and system for long-term cycle testing of a valve body for leaks in a subsea environment. One embodiment of a test assembly according to the present invention is shown in FIG. 1.

As depicted therein, test assembly 100 comprises a test frame 102. The valve 108 undergoing testing is secured to the frame 102 in one embodiment by bolts 126 located at a valve attachment area of the test frame 102. Other means of securing the valve to the test frame can be used, such as clamps. The portion of the test frame 102 that the valve is secured to may comprise holes or angled surfaces that allow bubbles generated by the valve to percolate up towards the bubble catch plate 106.

The valve 108 comprises an inlet 122, an outlet 124, and an actuator 120. The actuator 120 is connected to a torque motor 116 through a shaft 128. The amount of torque applied to the shaft 128 is measured by torque sensor 104.

Disposed above the valve 108 is a bubble catch plate 106. The bubble catch plate 106 can also be secured to the test frame 102. Bubble catch plate 106 is designed to catch any bubbles that emerge from the valve 108 and direct them to gas capture tube orifice 112. Gas capture tube orifice 112 is an orifice in the bubble catch plate 106 that allows gas bubbles to pass through the bubble catch plate, and into gas capture tube 114. The shaft 128 passes through the bubble catch plate 106 through water and gas tight connection, such as passing the shaft through a rubber diaphragm. In a preferred embodiment, the bubble catch plate is made of a clear or translucent material so that the presence of bubbles can be visually confirmed.

In one embodiment, the bubble catch plate comprises a funnel surface facing the valve. The funnel surface can be any shape that, when impacted by a rising bubble, diverts the direction of travel of the bubble towards the gas capture tube orifice. Most generally, the funnel surface is an inclined surface that directs a rising bubble towards a portion of the surface or bubble catch plate further away from the valve.

Funnels are generally known and used in the art to direct the flow of solids or liquids under the influence of gravity. The most iconic form of a funnel is an inverted frustum of a cone or pyramid with a hole near the apex of the narrow portion of the frustum. When liquids or solid particles are poured into the large end of the frustum, they are directed towards the small end of the frustum as they fall under the force of gravity. The walls of the frustum may be smooth or may comprise surface features, such as ridges or channels, which further direct the flow of solids or liquids through the funnel.

The present invention uses a funnel surface to direct the flow of a bubble that is rising in a liquid, against the force of gravity, because it is less dense than the liquid. As used herein, a funnel surface is at least a portion of a funnel that redirects flow in a particular direction. The funnel surface can be a portion of a frustum (a curved or flat surface, which may be smooth or may include other surface features) or an entire frustum. The frustum need not be a frustum of a regular geometric shape, but preferably is.

In the embodiment disclosed in FIG. 1, from the perspective of the viewer, rising bubbles will be directed towards the viewer by the funnel surface of bubble catch plate 106. The embodiment in FIG. 1 also includes an additional funnel surface feature. In this embodiment, the bubble catch plate 106 comprises a bubble catch channel 118 around the periphery of the funnel surface of the bubble catch plate. Because the channel is wider than the typical bubble that would emerge from a malfunctioning valve, the bubble will get caught in the bubble catch channel, and as it rises, the bubble catch channel directs the bubble around the periphery of the funnel surface and towards the gas capture tube orifice.

With further reference to FIG. 1, gas capture tube orifice 112 is connected to a gas capture tube 114. Gas bubbles travel through gas capture tube orifice 112, then through gas capture tube 114, and then measured by a gas flow meter (not shown) coupled to the gas capture tube. The gas flow meter can be any meter known in the art with sensitivity to detect small gas bubbles emerging from a leaky valve. The meter can take measurements based on mass or volume, as these quantities are readily convertible based on known properties of the gas. One example of a gas flow meter that can be used is a Cole Palmer Whisper mass flow sensor, model number 32435-21.

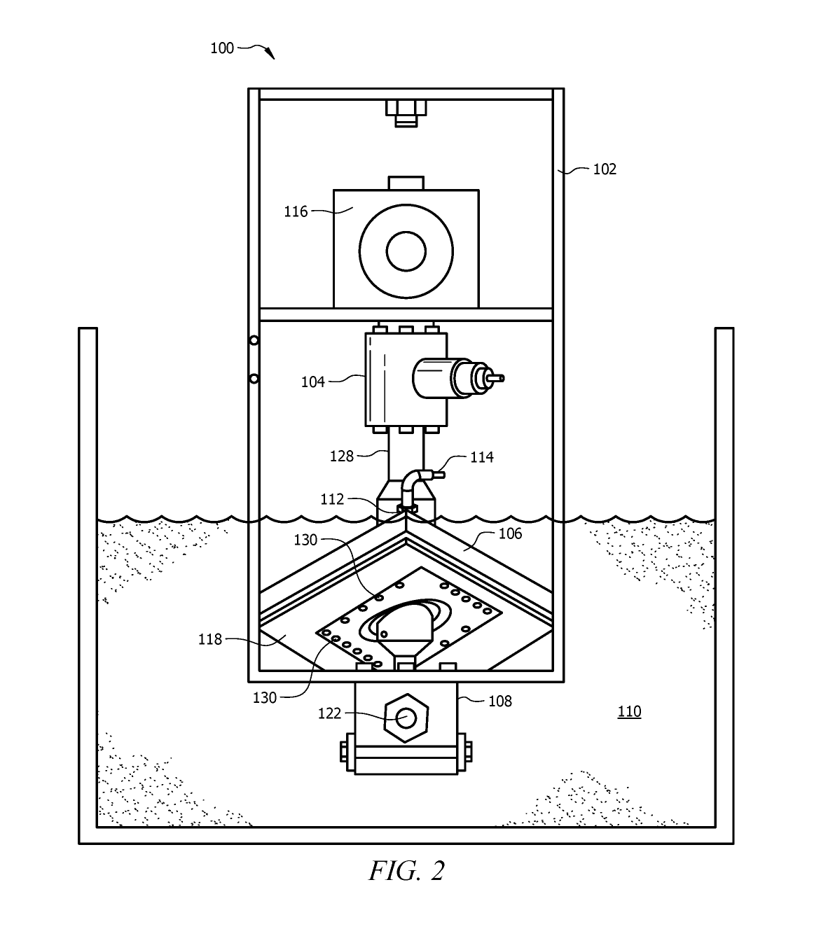

FIG. 2 depicts a cross sectional view of one embodiment of the valve test assembly conducting a valve test. To conduct a leak test for a valve using the valve testing assembly 100 of the present invention, a valve 108 is attached to the testing assembly at the valve attachment area, pressurized with nitrogen gas, and immersed into a liquid bath 110. In particular, the test assembly is vertically lowered into the test bath 110 until the top of the test bath fluid is substantially aligned with the location where the gas capture tube connects to the gas capture tube orifice on the bubble catch plate. Pressure at the valve outlet is also measured.

While the inlet side of the valve is pressurized, the torque motor cycles the valve actuator between on and off positions. All of the gas that enters the valve inlet should pass through the valve body and out through the valve outlet. Any leaks in the valve will produce bubbles 130 that rise up from the valve body. Rising bubbles 130 impact the bubble catch plate 106, and are directed towards and through the gas capture tube orifice 112 and into the gas capture tube 114, where they are analyzed by a gas flow meter (not shown).

The test bath temperature can be varied during the valve test to simulate cold conditions (for example, about −18 degrees Celsius), hot conditions (for example, about 150 degrees Celsius), or any desired temperature in between. During the test, the valve is cycled between the on and off positions any desired number of times, but preferably thousands of cycles, while the gas flow meter continuously monitors the test bath for bubbles.

The benefits of the present invention over the prior art are numerous and substantial. In the prior art, a test valve assembly was visually monitored for bubbles by a human operator. The operator would watch as the valve was cycled between the on and off positions, and note the number and approximate size of any bubbles that emerged from the valve assembly. This arrangement required diligent focus and attention on the part of the operator. The bubbles that are produced by a leaky valve can be very small and intermittent.

By contrast, the valve testing assembly of the present invention can be continuously monitored by a computerized system that is connected to the torque motor and the gas flow meter. Once the system is set up and turned on, the accuracy of the system is independent of operator skill or ability. The system also allows for long-duration tests without risk of operator fatigue. Furthermore, the inventive system herein is capable of making quantitative measurements, whereas a human operator's observations are more qualitative. Also, the results are highly consistent between tests

Virtually any type of valve, including ball valves, can be tested using the test assembly described herein. The valve testing assembly of the present invention is particularly useful for testing valves used in subsea environments of oil and gas exploration activities.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

What is claimed is:

1. A valve test assembly comprising:
a test frame;
a torque motor secured to the test frame;
an actuator shaft coupled to the torque motor;
a torque sensor that measures the amount of torque applied to the actuator shaft;
a valve attachment area on the test frame;
a bubble catch plate secured to the test frame between the valve attachment area and the torque motor; wherein the bubble catch plate comprises a funnel surface facing the valve attachment area, further wherein the bubble catch plate comprises a gas tube orifice connected to a gas capture tube on a side of the bubble catch plate opposite the valve attachment area.

2. The valve test assembly of claim 1 wherein the funnel surface comprises an angled surface.

3. The valve test assembly of claim 1 wherein the funnel surface comprises at least one groove.

4. The valve test assembly of claim 1 further comprising a gas flow meter coupled to the gas capture tube.

5. The valve test assembly of claim 1 further comprising a valve attached to the valve attachment area of the test frame.
